(19) United States
(12) Patent Application Publication
(10) Pub. No.: US 2022/0083954 A1
(43) Pub. Date: Mar. 17, 2022

(54) METHODS AND SYSTEMS FOR REAL-TIME INVENTORY REALLOCATION FROM SUPPLIER TO RETAILER

(71) Applicant: Shopify Inc., Ottawa (CA)

(72) Inventor: Julia STAROSTENKO, Berlin (DE)

(21) Appl. No.: 17/018,922

(22) Filed: Sep. 11, 2020

(51) Int. Cl. G06Q 10/08; G06Q 30/02

(52) U.S. Cl. CPC G06Q 10/087; G06Q 30/0205

(57) ABSTRACT

Methods and systems for reallocation of inventory from a supplier to a retailer are described. To fulfill a retailer's order for a total number of units of a product, a supplier's inventory data is updated by decreasing unit counts across different warehouses in different geographic regions, and the retailer's inventory data is updated by increasing unit counts correspondingly. After detecting an event that is indicative of demand for the product at a first geographical region, a first number of units is reallocated to a first warehouse at the first geographic location from a second warehouse at a second geographic region. The supplier's inventory data is updated by decreasing the unit count at the first warehouse by the reallocated number and increasing the unit count at the second warehouse by the reallocated number. The retailer's inventory data is updated correspondingly.

### FIELD

The present disclosure is related to allocation of inventory from a supplier to a retailer, across warehouses in different geographic regions. In particular, the present disclosure relates to methods and systems for automatic real-time reallocation of inventory, in response to predicted or actual geographic demand.

### BACKGROUND

Conventionally, a wholesale supplier may fulfill an order from a retailer by shipping the purchased products to the retailer. The shipping process can be expensive, time-consuming and carbon-intensive, which can be undesirable for both the supplier and the retailer. Generally, costs related to shipping should be understood to include not only monetary costs, but also time costs, environmental costs, and costs associated with maintaining and managing a greater number of vehicles (e.g., if supplier or retailer owns their own vehicles), among others. Costs related to shipping need not be directly related to shipping distance.

Conventionally, the fulfillment process may be slow or unable to respond to the retailer's actual needs. For example, if a retailer is running low on products at a first geographic region but has an excess at a second geographic region, it is up to the retailer to identify this need and manage shipping of products from the second to the first region. If the retailer is unable to anticipate this need in advance, or if the retailer fails to identify this need, the result may be delayed shipment to consumers at the first region, or lost sales at the first region, as well as possibly increased storage costs being incurred for storing excess product at the second region.

### SUMMARY

In various examples, the present disclosure describes methods and systems that enable automatic allocation of inventory from a supplier to a retailer using the same fulfillment platform. Units of the products can be allocated from a supplier to a retailer, across different warehouses in different geographic regions. Further, inventory can be reallocated between the supplier and retailer, across the different regions in real-time, in response to predicted or actual consumer demand. Conveniently, in this way, inventory may be more efficiently and/or more effectively managed dynamically between a supplier and a retailer.

In some examples, the present disclosure describes a method of inventory management, including: receiving, from a device associated with a retailer, an order for a total number of units of a product; allocating the total number of units of the product to the retailer by: in supplier inventory data associated with a supplier, decreasing unit counts associated with respective different warehouses in respective different geographic regions by respective numbers of units of the product; and in retailer inventory data associated with the retailer, increasing unit counts associated with the respective different warehouses by the respective numbers of units of the product; detect an event, the event being indicative of demand for the product at a first geographical region; and responsive to detecting the event, reallocating a first number of units of the product to a first warehouse at the first geographic location from a second warehouse at a second geographic region by: in the supplier inventory data, decreasing the unit count associated with the first warehouse by the first number of units and increasing the unit count associated with the second warehouse by the first number of units; and in the retailer inventory data, increasing the unit count associated with the first warehouse by the first number of units and decreasing the unit count associated with the second warehouse by the first number of units.

In any of the examples, the event may be detected in real-time, and the reallocating may be performed in real-time with occurrence of the event.

In any of the examples, the event may be based on one or more of: a marketing campaign associated with the retailer or the supplier, the marketing campaign being associated with the first geographical region; a change in actual demand for the product at the first geographical region or at the second geographical region; or a change in online consumer activity associated with the product, the change being indicative of increased predicted demand at the first geographical region or decreased predicted demand at the second geographical region.

In any of the examples, the respective numbers of units of the product may be allocated to the warehouses at respective different geographical regions based on predicted demand at the respective different geographical regions.

In any of the examples, the method may include: generating an estimation of the predicted demand based on at least one of: demand for the product at another retailer; demand for another related product; demand for the product category; predicted response to a planned marketing campaign; consumer searches for the product; or consumer views of an online page associated with the product.

In any of the examples, the method may include: generating an estimation of the predicted demand by assigning a respective demand weight to respective factors; and calculating an aggregation of weighted factors as an estimation of the predicted demand.

In any of the examples, the event may be detection of actual demand that is mismatched with the predicted demand.

In any of the examples, the respective numbers of units of the product may be allocated based on one or more retailer-defined criteria.

In any of the examples, the retailer-defined criteria may include one or more of: reducing shipping time; reducing transportation costs; reducing storage costs; or reducing carbon emissions.

In some examples, the present disclosure describes a system including a processor in communication with storage. The processor is configured to execute instructions from the storage to cause the system to: receive, from a device associated with a retailer, an order for a total number of units of a product; allocate the total number of units of the product to the retailer by: in supplier inventory data associated with a supplier, decreasing unit counts associated with respective different warehouses in respective different geographic regions by respective numbers of units of the product; and in retailer inventory data associated with the retailer, increasing unit counts associated with the respective different warehouses by the respective numbers of units of the product; detect an event, the event being indicative of demand for the product at a first geographical region; and responsive to detecting the event, reallocate a first number of units of the product to a first warehouse at the first geographic location from a second warehouse at a second geographic region by: in the supplier inventory data, decreasing the unit count associated with the first warehouse by the first number of units and increasing the unit count associated with the second warehouse by the first number of units; and in the retailer inventory data, increasing the unit count associated with the first warehouse by the first number of units and decreasing the unit count associated with the second warehouse by the first number of units.

The processor may be configured to execute instructions to cause the system to perform any of the methods described herein.

In some examples, the present disclosure describes a computer-readable medium storing instructions that, when executed by a processor of a system, cause the system to: receive, from a device associated with a retailer, an order for a total number of units of a product; allocate the total number of units of the product to the retailer by: in supplier inventory data associated with a supplier, decreasing unit counts associated with respective different warehouses in respective different geographic regions by respective numbers of units of the product; and in retailer inventory data associated with the retailer, increasing unit counts associated with the respective different warehouses by the respective numbers of units of the product; detect an event, the event being indicative of demand for the product at a first geographical region; and responsive to detecting the event, reallocate a first number of units of the product to a first warehouse at the first geographic location from a second warehouse at a second geographic region by: in the supplier inventory data, decreasing the unit count associated with the first warehouse by the first number of units and increasing the unit count associated with the second warehouse by the first number of units; and in the retailer inventory data, increasing the unit count associated with the first warehouse by the first number of units and decreasing the unit count associated with the second warehouse by the first number of units.

The instructions, when executed by the processor, may cause the system to perform any of the methods described herein.

### BRIEF DESCRIPTION OF THE DRAWINGS

Reference will now be made, by way of example, to the accompanying drawings which show example embodiments of the present application, and in which:

FIG. 1 is a block diagram of an example e-commerce platform, in which examples described herein may be implemented;

FIG. 2 is an example homepage of an administrator, which may be accessed via the e-commerce platform of FIG. 1;

FIG. 3 is another block diagram of the e-commerce platform of FIG. 1, showing some details related to application development;

FIG. 4 shows an example data flow that may take place when a purchase is made using the e-commerce platform of FIG. 1;

FIG. 5 is a block diagram illustrating an example implementation of the e-commerce platform of FIG. 1;

FIG. 6 is another block diagram of the e-commerce platform of FIG. 1, showing some details related to allocation of inventory between supplier and retailer;

FIG. 7 is a flowchart illustrating an example method for allocating inventory from a supplier to a retailer;

FIG. 8 is a diagram illustrating an example of allocating inventory from a supplier to a retailer;

FIG. 9 is a flowchart illustrating an example method for reallocating inventory from a supplier to a retailer, in response to geographic demand; and

FIG. 10 is a diagram illustrating an example of reallocating inventory from a supplier to a retailer, in response to geographic demand.

Similar reference numerals may have been used in different figures to denote similar components.

### DESCRIPTION OF EXAMPLE EMBODIMENTS

The present disclosure will be described in the context of an e-commerce platform, discussed below. However, it should be understood that this discussion is only for the purpose of illustration and is not intended to be limiting. Further, it should be understood that the present disclosure may be implemented in other contexts, and is not necessarily limited to implementation in an e-commerce platform.

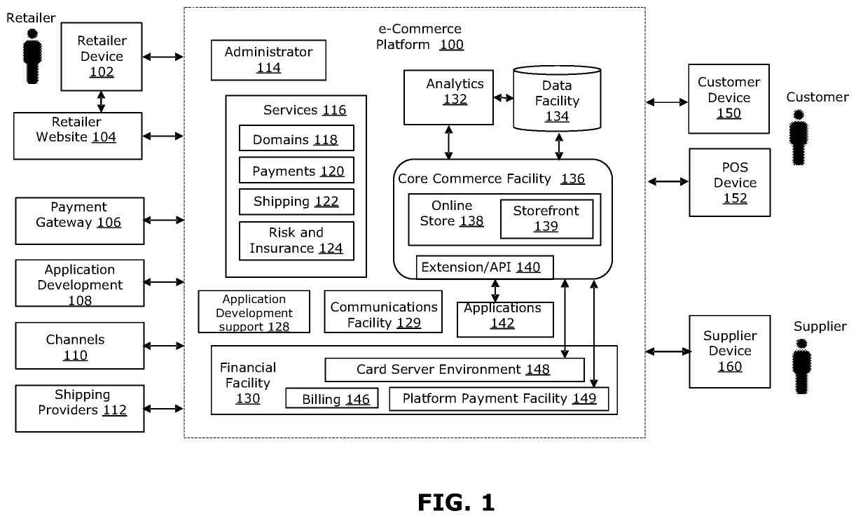

With reference to FIG. 1, an example embodiment of an e-commerce platform 100 is depicted for providing retailer products and services to customers. The e-commerce platform 100 in this example also enables business-to-business (B2B) commercial transactions, for example between wholesale suppliers (referred to herein simply as “suppliers”) and retailers (also referred to in some instances as “merchants”). The present disclosure describes transactions related to physical products. However, the present disclosure is not limited to commercial transactions of physical products. In some instances, a purchase or sale may have both physical and non-physical aspects (e.g., a service may be associated with sale of a physical product). The e-commerce platform 100 may also be referred to as a fulfillment platform and may be used to manage movement of inventory to and from a network of physical warehouses. The network of warehouses may be at different geographic locations, for example distributed across a region, across a country, or across the world. Suppliers and retailers may store inventory across the network of warehouses.

While the disclosure throughout contemplates that a “supplier”, a “retailer”, a “user” and a “customer” may be more than individuals, for simplicity the description herein may generally refer to suppliers, retailers, users and customers as such. All references to suppliers, retailers, users and customers throughout this disclosure should also be understood to be references to groups of individuals, companies, corporations, computing entities, and the like, and may represent for-profit or not-for-profit exchange of products. Further, while the disclosure throughout refers to “suppliers”, “retailers”, and “customers”, and describes their roles as such, it should be understood that retailers and customers may also be generally referred to as users of the e-commerce platform 100, and aspects of the e-commerce platform 100 may be more generally available to support users in an e-commerce environment. All references to suppliers, retailers and customers throughout this disclosure should also be understood to be references to users, such as where a user is a supplier-user (e.g., a B2B seller, wholesaler, or B2B provider of products), a retailer-user (e.g., a seller, retailer, or provider of products), or a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Further, it should be understood that any individual or group of individuals may play more than one role and may fit more than one label in the e-commerce environment. For example, a corporate user may also be a customer.

The e-commerce platform 100 may provide a centralized system for providing retailers with online resources for managing their business. Retailers may utilize the e-commerce platform 100 for managing commerce with customers, such as by implementing an e-commerce experience with customers through an online store 138, through channels 110, through point of sale (POS) devices 152 in physical locations (e.g., a physical storefront or other location such as through a kiosk, terminal, reader, printer, 3D printer, and the like), by managing their business through the e-commerce platform 100, by interacting with customers through a communications facility 129 of the e-commerce platform 100, or any combination thereof. A retailer may sell products through both physical storefronts and the virtual storefront 139 of the online store 138.

The e-commerce platform 100 may also provide a centralized system for enabling B2B transactions between retailers and suppliers. Suppliers may, using a supplier device 160 for example, manage commerce with retailers in a manner similar to how retailers manage commerce with customers. For example, suppliers may manage an online store 138 that is accessible to retailers. For simplicity, the following discussion will be in the context of an online store 138 associated with a retailer, however it should be understood that the discussion may be similarly applicable to suppliers.

The online store 138 may represent a multitenant facility comprising a plurality of virtual storefronts 139. In various embodiments, retailers may manage one or more storefronts 139 in the online store 138, such as through a retailer device 102 (e.g., computer, laptop computer, mobile computing device, and the like), and offer products to customers through a number of different channels 110 (e.g., an online store 138; a physical storefront through a POS device 152; electronic marketplace, through an electronic buy button integrated into a website or social media channel such as on a social network, social media page, social media messaging system; and the like). A retailer may sell across channels 110 and then manage their sales through the e-commerce platform 100. A retailer may sell in their physical retail store, at pop ups, through wholesale, over the phone, and the like, and then manage their sales through the e-commerce platform 100. A retailer may employ all or any combination of these, such as maintaining a business through a physical storefront utilizing POS devices 152, maintaining a virtual storefront 139 through the online store 138, and utilizing the communications facility 129 to leverage customer interactions and analytics 132 to improve the probability of sales, for example.

In various embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable retailers to reach customers through the online store 138, through POS devices 152 in physical locations (e.g., a retailer's storefront or elsewhere), to promote commerce with customers through dialog via electronic communication, and the like, providing a system for reaching customers and facilitating retailer services for the real or virtual pathways available for reaching and interacting with customers.

In various embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, retailer devices 102, payment gateways 106, application development 108, channels 110, shipping providers 112, customer devices 150, POS devices 152, supplier devices 160, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a thin client via a web browser, accessed through by POS devices 152, and the like). In various embodiments, elements of the e-commerce platform 100 may be implemented to operate on various platforms and operating systems, such as iOS, Android, over the internet, and the like.

In various embodiments, storefronts 139 may be served by the e-commerce platform 100 to customers (e.g., via customer devices 150), where customers can browse and purchase the various products available (e.g., add them to a cart, purchase immediately through a buy-button, and the like). Storefronts 139 may be served to customers in a transparent fashion without customers necessarily being aware that it is being provided through the e-commerce platform 100 (rather than directly from the retailer). Retailers may use a retailer configurable domain name, a customizable HTML theme, and the like, to customize their storefront 139. Retailers may customize the look and feel of their website through a theme system, such as where retailers can select and change the look and feel of their storefront 139 by changing their theme while having the same underlying product and business data shown within the storefront's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a basic content management system for website content. Retailers may author blog posts or static pages and publish them to their storefront 139 and/or website 104, such as through blogs, articles, and the like, as well as configure navigation menus. Retailers may upload images (e.g., for products), video, content, data, and the like to the e-commerce platform 100, such as for storage by the system. In various embodiments, the e-commerce platform 100 may provide functions for resizing images, associating an image with a product, adding and associating text with an image, adding an image for a new product variant, protecting images, and the like.

As described herein, the e-commerce platform 100 may provide retailers with transactional facilities for products through a number of different channels 110, including the online store 138, over the telephone, as well as through physical POS devices 152 as described herein. The e-commerce platform 100 may provide business support services 116, an administrator component 114, and the like associated with running an on-line business, such as providing a domain service 118 associated with their online store, payments services 120 for facilitating transactions with a customer, shipping services 122 for providing customer shipping options for purchased products, risk and insurance services 124 associated with product protection and liability, retailer billing services 146, and the like. Services 116 may be provided via the e-commerce platform 100 or in association with external facilities, such as through a payment gateway 106 for payment processing, shipping providers 112 for expediting the shipment of products, and the like.

In various embodiments, the e-commerce platform 100 may provide for integrated shipping services 122 (e.g., through an e-commerce platform shipping facility or through a third-party shipping carrier), such as providing retailers with real-time updates, tracking, automatic rate calculation, bulk order preparation, label printing, and the like.

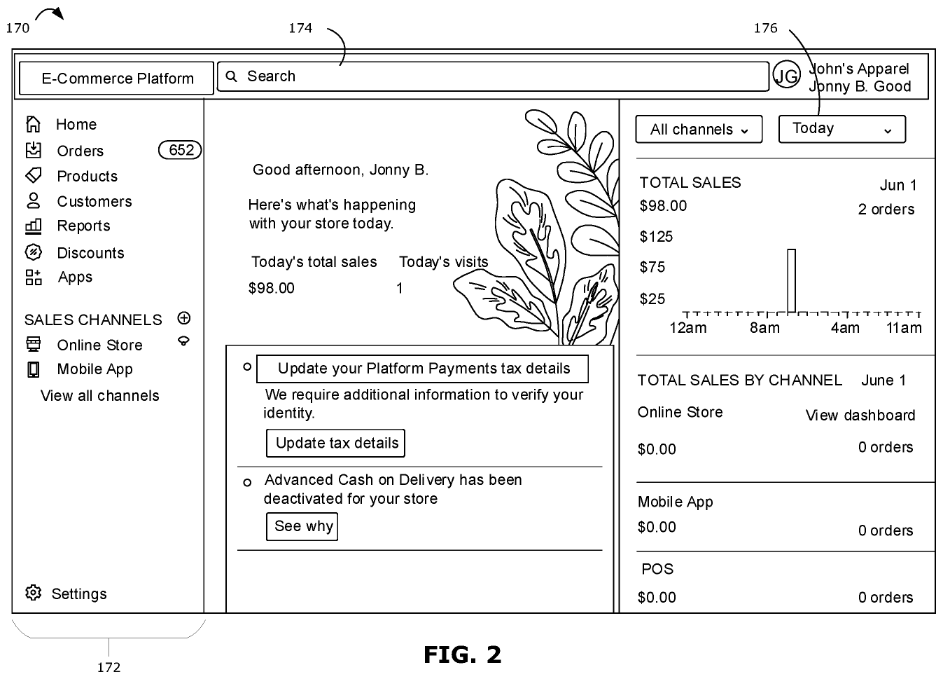

FIG. 2 depicts a non-limiting embodiment for a home page 170 of an administrator 114, which may show information about daily tasks, a store's recent activity, and the next steps a retailer can take to build their business. In various embodiments, a retailer may log in to administrator 114, such as from a browser or mobile device, and manage aspects of their storefront, such as viewing the storefront's recent activity, updating the storefront's catalog, managing orders, recent visits activity, total orders activity, and the like. In various embodiments, the retailer may be able to access the different sections of administrator 114 by using the sidebar 172, such as shown on FIG. 2. Sections of the administrator may include core aspects of a retailer's business, including orders, products, and customers; sales channels, including the online store, POS, and buy button; applications installed on the retailer's account; settings applied to a retailer's storefront 139 and account. A retailer may use a search bar 174 to find products, pages, or other information. Depending on the device the retailer is using, they may be enabled for different functionality through the administrator 114. For instance, if a retailer logs in to the administrator 114 from a browser, they may be able to manage all aspects of their storefront 139. If the retailer logs in from their mobile device, they may be able to view all or a subset of the aspects of their storefront 139, such as viewing the storefront's recent activity, updating the storefront's catalog, managing orders, and the like.

More detailed information about commerce and visitors to a retailer's storefront 139 may be viewed through acquisition reports or metrics, such as displaying a sales summary for the retailer's overall business, specific sales and engagement data for active sales channels, and the like. Reports may include, acquisition reports, behavior reports, customer reports, finance reports, marketing reports, sales reports, custom reports, and the like. The retailer may be able to view sales data for different channels 110 from different periods of time (e.g., days, weeks, months, and the like), such as by using drop-down menus 176. An overview dashboard may be provided for a retailer that wants a more detailed view of the store's sales and engagement data. An activity feed in the home metrics section may be provided to illustrate an overview of the activity on the retailer's account. For example, by clicking on a “view all recent activity” dashboard button, the retailer may be able to see a longer feed of recent activity on their account. A home page may show notifications about the retailer's storefront 139, such as based on account status, growth, recent customer activity, and the like. Notifications may be provided to assist a retailer with navigating through a process, such as capturing a payment, marking an order as fulfilled, archiving an order that is complete, and the like.

Reference is made back to FIG. 1. The e-commerce platform may provide for a communications facility 129 and associated retailer interface for providing electronic communications and marketing, such as utilizing an electronic messaging aggregation facility (not shown) for collecting and analyzing communication interactions between retailers, customers, retailer devices 102, customer devices 150, POS devices 152, and the like, to aggregate and analyze the communications, such as for increasing the potential for providing a sale of a product, and the like. For instance, a customer may have a question related to a product, which may produce a dialog between the customer and the retailer (or automated processor-based agent representing the retailer), where the communications facility 129 analyzes the interaction and provides analysis to the retailer on how to improve the probability for a sale.

The e-commerce platform 100 may provide a financial facility 130 for secure financial transactions with customers, such as through a secure card server environment 148. The e-commerce platform 100 may store credit card information, such as in payment card industry data (PCI) environments (e.g., a card server), to reconcile financials, bill retailers, perform automated clearing house (ACH) transfers between an e-commerce platform 100 financial institution account and a retailer's bank account (e.g., when using capital), and the like. These systems may have Sarbanes-Oxley Act (SOX) compliance and a high level of diligence required in their development and operation. The financial facility 130 may also provide retailers with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new retailers with the e-commerce platform 100. These services may enable retailer growth by making it easier for retailers to work across the e-commerce platform 100. Through these services, retailers may be provided help facilities via the e-commerce platform 100.

In various embodiments, online store 138 may support a great number of independently administered storefronts 139 and process a large volume of transactional data on a daily basis for a variety of products. Transactional data may include customer contact information, billing information, shipping information, information on products purchased, information on services rendered, and any other information associated with business through the e-commerce platform 100. In various embodiments, the e-commerce platform 100 may store this data in a data facility 134. The transactional data may be processed to produce analytics 132, which in turn may be provided to retailers or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and retailer transactions, and the data facility 134 may have many ways of enhancing, contributing, refining, and extracting data, where over time the collected data may enable improvements to aspects of the e-commerce platform 100.

In various embodiments, the e-commerce platform 100 may be configured with a core commerce facility 136 for content management and task automation to enable support and services to the plurality of storefronts 139 (e.g., related to products, inventory, customers, orders, collaboration, suppliers, reports, financials, risk and fraud, and the like), but be extensible through applications 142 that enable greater flexibility and custom processes required for accommodating an ever-growing variety of retailer storefronts 139, POS devices 152, products, and services. For instance, the core commerce facility 136 may be configured for flexibility and scalability through portioning (e.g., sharding) of functions and data, such as by customer identifier, order identifier, storefront identifier, and the like. The core commerce facility 136 may accommodate store-specific business logic and a web administrator. The online store 138 may represent a channel, be embedded within the core commerce facility 136, provide a set of support and debug tools that support uses for retailers, and the like. The core commerce facility 136 may provide centralized management of critical data for storefronts 139.

The core commerce facility 136 includes base or “core” functions of the e-commerce platform 100, and as such, as described herein, not all functions supporting storefronts 139 may be appropriate for inclusion. For instance, functions for inclusion into the core commerce facility 136 may need to exceed a core functionality threshold through which it may be determined that the function is core to a commerce experience (e.g., common to a majority of storefront activity, such as across channels, administrator interfaces, retailer locations, industries, product types, and the like), is re-usable across storefronts (e.g., functions that can be re-used/modified across core functions), limited to the context of a single storefront at a time (e.g., implementing a storefront “isolation principle”, where code should not be able to interact with multiple storefronts at a time, ensuring that storefronts cannot access each other's data), provide a transactional workload, and the like. Maintaining control of what functions are implemented may enable the core commerce facility 136 to remain responsive, as many required features are either served directly by the core commerce facility 136 or enabled by its extension/application programming interface (API) 140 connection to applications 142. If care is not given to restricting functionality in the core commerce facility 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the core commerce facility 136 may be configured to maintain responsiveness, such as through configuration that utilizes timeouts, queues, back-pressure to prevent degradation, and the like.

Although isolating storefront data is important to maintaining data privacy between storefronts 139 and retailers, there may be reasons for collecting and using cross-store data, such as for example, with an order risk assessment system or a platform payment facility, both of which require information from a majority of storefronts 139 to perform well. In various embodiments, rather than violating the isolation principle, it may be preferred to move these components out of the core commerce facility 136 and into their own infrastructure within the e-commerce platform 100. For example, the data facility 134 and analytics 132 may be located outside the core commerce facility 136.

In various embodiments, the e-commerce platform 100 may provide for a platform payment facility 149, which is another example of a component that utilizes data from the core commerce facility 138 but may be located outside so as to not violate the isolation principle. The platform payment facility 149 may allow customers interacting with storefronts 139 to have their payment information stored safely by the core commerce facility 136 such that they only have to enter it once. When a customer visits a different storefront 139, even if they've never been there before, the platform payment facility 149 may recall their information to enable a more rapid and correct check out. This may provide a cross-platform network effect, where the e-commerce platform 100 becomes more useful to its retailers as more retailers join, such as because there are more customers who checkout more often because of the ease of use with respect to customer purchases. To maximize the effect of this network, payment information for a given customer may be retrievable from a storefront's checkout, allowing information to be made available globally across storefronts 139. It would be difficult and error prone for each storefront 139 to be able to connect to any other storefront 139 to directly retrieve the payment information stored there. As a result, the platform payment facility 149 may be implemented external to the core commerce facility 136.

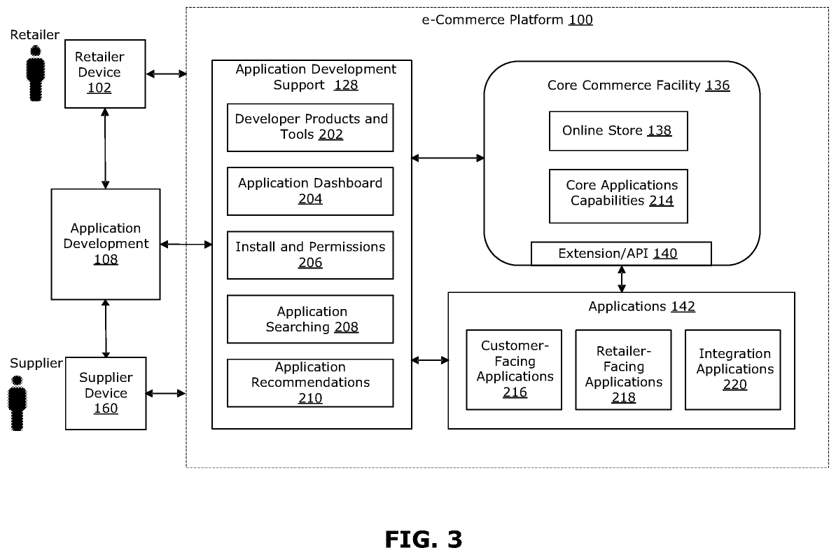

For those functions that are not included within the core commerce facility 138, applications 142 provide a way to add features to the e-commerce platform 100. Applications 142 may be able to access and modify data on a retailer's storefront 139, perform tasks through the administrator 114, create new flows for a retailer through a user interface (e.g., that is surfaced through extensions/API 140), and the like. Retailers may be enabled to discover and install applications 142 through application searching 208 and application recommendations 210 (see FIG. 3). In various embodiments, core products, core extension points, applications, and the administrator 114 may be developed to work together. For instance, application extension points may be built inside the administrator 114 so that core features may be extended by way of applications 142, which may deliver functionality to a retailer through the extension/API 140.

In various embodiments, applications 142 may deliver functionality to a retailer through the extension/API 140, such as where an application 142 is able to surface transaction data to a retailer (e.g., App: “Surface my app in mobile and web admin using the embedded app SDK”), and/or where the core commerce facility 136 is able to ask the application to perform work on demand (core: “App, give me a local tax calculation for this checkout”).

Applications 142 may support storefronts 139 and channels 110, provide retailer support, integrate with other services, and the like. Where the core commerce facility 136 may provide the foundation of services to the storefront 139, the applications 142 may provide a way for retailers to satisfy specific and sometimes unique needs. Different retailers will have different needs, and so may benefit from different applications 142. Applications 142 may be better discovered through the e-commerce platform 100 through development of an application taxonomy (categories) that enable applications to be tagged according to a type of function it performs for a retailer; through application data services that support searching, ranking, and recommendation models; through application discovery interfaces such as an application store, home information cards, an application settings page; and the like.

Applications 142 may be connected to the core commerce facility 136 through an extension/API layer 140, such as utilizing APIs to expose the functionality and data available through and within the core commerce facility 136 to the functionality of applications (e.g., through REST, GraphQL, and the like). For instance, the e-commerce platform 100 may provide API interfaces to retailer and partner-facing products and services, such as may include, for example, application extensions, process flow services, developer-facing resources, and the like. With customers more frequently using mobile devices for shopping, applications 142 related to mobile use may benefit from more extensive use of APIs to support the related growing commerce traffic. The flexibility offered through use of applications and APIs (e.g., as offered for application development) enable the e-commerce platform 100 to better accommodate new and unique needs of retailers (and internal developers through internal APIs) without requiring constant change to the core commerce facility 136, thus providing retailers what they need when they need it. For instance, shipping services 122 may be integrated with the core commerce facility 136 through a shipping or carrier service API, thus enabling the e-commerce platform 100 to provide shipping service functionality without directly impacting code running in the core commerce facility 136.

Many retailer problems may be solved by letting partners (e.g., third-party service providers) improve and extend retailer workflows through application development, such as problems associated with back-office operations (retailer-facing applications) and in the storefront (customer-facing applications). As a part of doing business, many retailers will use mobile and web related applications on a daily basis for back-office tasks (e.g., merchandising, inventory, discounts, fulfillment, and the like) and storefront tasks (e.g., applications related to their online shop, for flash-sales, new product offerings, and the like), where applications 142, through extension/API 140, help make products easy to view and purchase in a fast growing marketplace. In various embodiments, partners, application developers, internal applications facilities, and the like, may be provided with a software development kit (SDK), such as through creating a frame within the administrator 114 that sandboxes an application interface. In various embodiments, the administrator 114 may not have control over nor be aware of what happens within the frame. The SDK may be used in conjunction with a user interface kit to produce interfaces that mimic the look and feel of the e-commerce platform 100, such as acting as an extension of the core commerce facility 136.

Applications 142 that utilize APIs may pull data on demand, but often they also need to have data pushed when updates occur. Update events may be implemented in a subscription model, such as for example, customer creation, product changes, or order cancelation. Update events may provide retailers with needed updates with respect to a changed state of the core commerce facility 136, such as for synchronizing a local database, notifying an external integration partner, and the like. Update events may enable this functionality without having to poll the core commerce facility 136 all the time to check for updates, such as through an update event subscription. In various embodiments, when a change related to an update event subscription occurs, the core commerce facility 136 may post a request, such as to a predefined callback URL. The body of this request may contain a new state of the object and a description of the action or event. Update event subscriptions may be created manually, in the administrator facility 114, or automatically (e.g., via the API). In various embodiments, update events may be queued and processed asynchronously from a state change that triggered them, which may produce an update event notification that is not distributed in real-time.

Reference is made to FIG. 3, which is another depiction of the e-commerce platform 100. FIG. 3 omits some details that have been described with reference to FIG. 1, and shows further details discussed below. In various embodiments, the e-commerce platform 100 may provide application development support 128. Application development support 128 may include developer products and tools 202 to aid in the development of applications, an application dashboard 204 (e.g., to provide developers with a development interface, to administrators for management of applications, to retailers for customization of applications, and the like), facilities for installing and providing permissions 206 with respect to providing access to an application 142 (e.g., for public access, such as where criteria must be met before being installed, or for private use by a retailer), application searching 208 to make it easy for a retailer to search for applications 142 that satisfy a need for their storefront 139, application recommendations 210 to provide retailers with suggestions on how they can improve the user experience through their storefront 139, a description of core application capabilities 214 within the core commerce facility 136, and the like. These support facilities may be utilized by application development 108 performed by any entity, including the retailer or supplier developing their own application 142, a third-party developer developing an application 142 (e.g., contracted by a retailer, developed on their own to offer to the public, contracted for use in association with the e-commerce platform 100, and the like), or an application being developed by internal personal resources associated with the e-commerce platform 100. In various embodiments, applications 142 may be assigned an application identifier (ID), such as for linking to an application (e.g., through an API), searching for an application, making application recommendations, and the like.

The core commerce facility 136 may include base functions of the e-commerce platform 100 and expose these functions through APIs to applications 142. The APIs may enable different types of applications built through application development 108. Applications 142 may be capable of satisfying a great variety of needs for retailers but may be grouped roughly into three categories: customer-facing applications 216, retailer-facing applications 218, or integration applications 220. Customer-facing applications 216 may include storefront 139 or channels 110 that are places where retailers can list products and have them purchased (e.g., the online store, applications for flash sales (e.g., retailer products or from opportunistic sales opportunities from third-party sources), a mobile store application, a social media channel, an application for providing wholesale purchasing, and the like). Retailer-facing applications 218 may include applications that allow the retailer to administer their storefront 139 (e.g., through applications related to the web or website or to mobile devices), run their business (e.g., through applications related to POS devices 152), to grow their business (e.g., through applications related to shipping (e.g., drop shipping), use of automated agents, use of process flow development and improvements), and the like. Integration applications 220 may include applications that provide useful integrations that participate in the running of a business, such as shipping providers 112 and payment gateways.

In various embodiments, an application developer may use an application proxy to fetch data from an outside location and display it on the page of an online storefront 139. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of retailer experiences to be built in applications 142 so that the core commerce facility 136 can remain focused on the more commonly utilized business logic of commerce.

The e-commerce platform 100 provides an online shopping experience through a curated system architecture that enables retailers to connect with customers in a flexible and transparent manner. A typical customer experience may be better understood through an embodiment example purchase workflow, where the customer browses the retailer's products on a channel 110, adds what they intend to buy to their cart, proceeds to checkout, and pays for the content of their cart resulting in the creation of an order for the retailer. The retailer may then view and fulfill (or cancel) the order. The product is then delivered to the customer. If the customer is not satisfied, they might return the products to the retailer.

In an example embodiment, a customer may browse a retailer's products on a channel 110. A channel 110 is a place where customers can view and buy products. In various embodiments, channels 110 may be modeled as applications 142 (a possible exception being the online store 138, which is integrated within the core commence facility 136). A merchandising component may allow retailers to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In various embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Retailers may use cart scripts to offer special promotions to customers based on the content of their cart. Since adding a product to a cart does not imply any commitment from the customer or the retailer, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the retailer commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable retailers to create discount codes (e.g., “secret” strings that when entered on the checkout apply new prices to the items in the checkout). Discounts may be used by retailers to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the retailer. Channels 110 may use the core commerce facility 136 to move money, currency or a store of value (such as dollars or a cryptocurrency) to and from customers and retailers. Communication with the various payment providers (e.g., online payment systems, mobile payment systems, digital wallet, credit card gateways, and the like) may be implemented within a payment processing component. The actual interactions with the payment gateways 106 may be provided through the card server environment 148. In various embodiments, the payment gateway 106 may accept international payment, such as integrating with leading international credit card processors. The card server environment 148 may include a card server application, card sink, hosted fields, and the like. This environment may act as the secure gatekeeper of the sensitive credit card information.

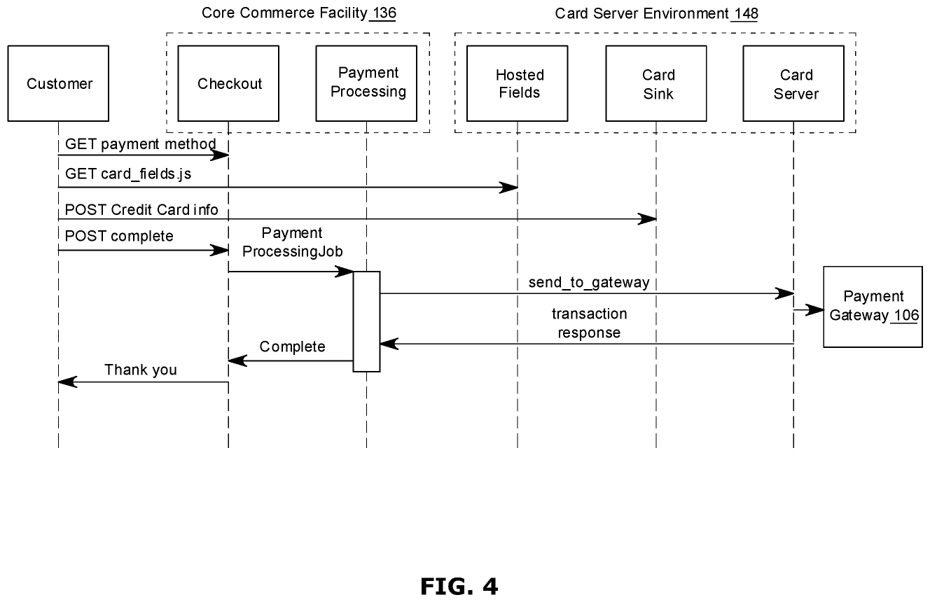

FIG. 4 presents, in a non-limiting example, a simplified sequence diagram of the interactions between the core commerce facility 136 and the card server environment 148 during payment processing of a credit, prepaid, gift or other card on a Web Checkout.

In various embodiments, most of the process may be orchestrated by a payment processing job. The core commerce facility 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the retailer and the customer where the retailer agrees to provide the goods and services listed on the orders (e.g., order line items, shipping line items, and the like) and the customer agrees to provide payment (including taxes). This process may be modeled in a sales component. Channels 110 that do not rely on core commerce facility checkouts may use an order API to create orders. Once an order is created, an order confirmation notification may be sent to the customer and an order placed notification sent to the retailer via a notifications component. Inventory may be reserved when a payment processing job starts to avoid over-selling (e.g., retailers may control this behavior from the inventory policy of each variant). Inventory reservation may have a short time span (minutes) and may need to be very fast and scalable to support flash sales (e.g., a discount or promotion offered for a short time, such as tailored towards impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a retailer facing concept that represents an item whose quantity and location is managed). An inventory level component may keep track of quantities that are available for sale, committed to an order or incoming from an inventory transfer component (e.g., from a vendor). The retailer may then view and fulfill (or cancel) the order.

An order assessment component may implement a business process retailers use to ensure orders are suitable for fulfillment before actually fulfilling them. Orders may be fraudulent, require verification (e.g., ID checking), have a payment method which requires the retailer to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the retailer may need to capture the payment information (e.g., credit card information) or wait to receive it (e.g., via a bank transfer, check, and the like) and mark the order as paid. The retailer may now prepare the products for delivery. In various embodiments, this business process may be implemented by a fulfillment component. The fulfillment component may group the line items of the order into a logical fulfillment unit of work based on an inventory location and fulfillment service. The retailer may assess the order, adjust the unit of work, and trigger the relevant fulfillment services, such as through a manual fulfillment service (e.g., at retailer managed locations) used when the retailer picks and packs the products in a box, purchase a shipping label and input its tracking number, or just mark the item as fulfilled. A custom fulfillment service may send an email (e.g., a location that does not provide an API connection). An API fulfillment service may trigger a third party, where the third-party application creates a fulfillment record. A legacy fulfillment service may trigger a custom API call from the core commerce facility 136 to a third party (e.g., fulfillment by Amazon). A gift card fulfillment service may provision (e.g., generating a number) and activate a gift card. Retailers may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the retailer. The business process retailers may go through to “un-sell” an item may be implemented by a returns component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that were not returned and remain in the customer's hands); and the like. A return may represent a change to the contract of sale (e.g., the order), and where the e-commerce platform 100 may make the retailer aware of compliance issues with respect to legal obligations (e.g., with respect to taxes). In various embodiments, the e-commerce platform 100 may enable retailers to keep track of changes to the contract of sales over time, such as implemented through a sales model component (e.g., an append-only date-based ledger that records sale-related events that happened to an item).

Although the above discussion relates to fulfillment of a customer order by a retailer, a similar process may be involved for fulfillment of a retailer order by a supplier. For example, a retailer may similarly shop for products on a supplier's storefront 139 and complete a similar checkout process to pay for the order. However, unlike sales to a customer, sales to a retailer may not require the supplier to ship product to the retailer, as will be explained further below.

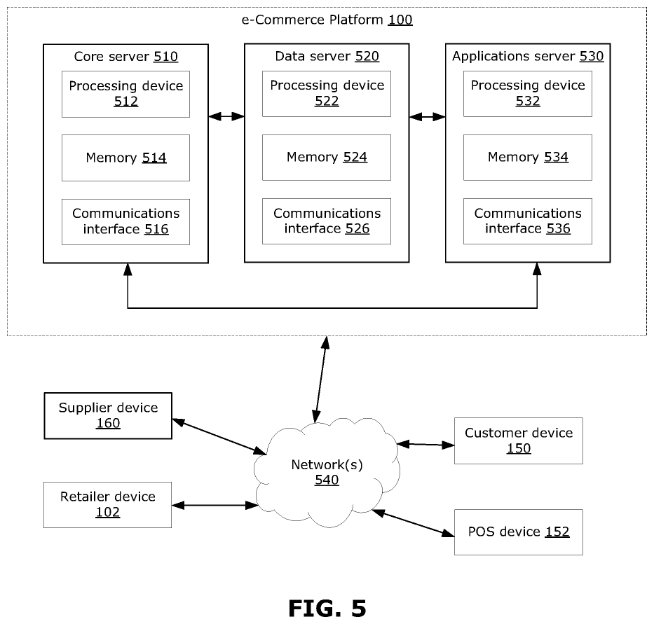

FIG. 5 is a block diagram of an example hardware configuration of the e-commerce platform 100. It should be noted that different components of the e-commerce platform 100 (e.g., the data facility 134, analytics facility 132, core commerce facility 136 and applications 142) may be implemented in separate hardware or software components, on a common hardware component or server or configured as a common (integrated) service or engine in the e-commerce platform 100. In the example of FIG. 5, the e-commerce platform 100 includes a core server 510, a data server 520 and an applications server 530, which are each in communication with each other (e.g., via wired connections and/or via wireless intranet connections). Each of the servers 510, 520, 530 include a respective processing device 512, 522, 532 (each of which may be, for example, a microprocessor, graphical processing unit, digital signal processor or other computational element), a respective memory 514, 524, 534 (each of which may be, for example, random access memory (RAM), read only memory (ROM), hard disk, optical disc, subscriber identity module (SIM) card, memory stick, secure digital (SD) memory card, and the like, and may include tangible or transient memory), and a respective communications interface 516, 526, 536 (each of which may include transmitter, receiver and/or transceiver for wired and/or wireless communications). The core server 510 may store instructions and perform operations relevant to core capabilities of the e-commerce platform, such as providing the administrator 114, analytics 132, core commerce facility 136, services 116 and/or financial facility 130, among others. The data server 520 may be used to implement the data facility 134, among others. The applications server 530 may store instructions and perform operations relevant to the applications 142, such as storing instructions and data for the applications 142 and for implementing application development support 128.

Suppliers, retailers and customers, using respective devices 102, 150, 152, 160 may access the e-commerce platform 100 via one or more networks 540 (e.g., wired and/or wireless networks, including a virtual private network (VPN), the Internet, and the like).

Although FIG. 5 illustrates an example hardware implementation of the e-commerce platform 100, it should be understood that other implementations may be possible. For example, there may be greater or fewer numbers of servers, the e-commerce platform 100 may be implemented in a distributed manner, or at least some of the memories 514, 524, 534 may be replaced with external storage or cloud-based storage, among other possible modifications.

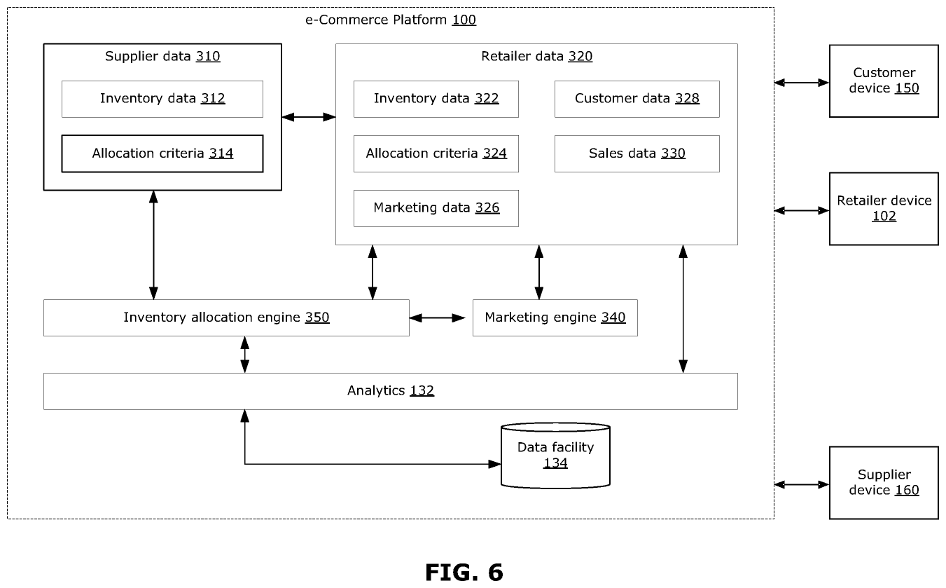

FIG. 6 is another depiction of the e-commerce platform 100 that omits some details that have been described with reference to FIG. 1, and shows further details discussed below. In particular, FIG. 6 illustrates some example details of the e-commerce platform 100 that are relevant to allocation of inventory between a supplier and a retailer.

In this example, the e-commerce platform 100 includes an inventory allocation engine 350 that is configured to use supplier data 310 and retailer data 320 stored in a computer-readable medium (e.g. in memory 524 or data facility 134) to manage allocation of inventory between a supplier and a retailer. These additional components may be part of and/or in two-way communication with the core commerce facility 136 or other commerce facility powering the supplier and retailer storefronts or on-line stores. The inventory allocation engine 350 performs the inventory allocation methods disclosed herein and may be implemented by one or more general-purpose processors (e.g. processing device 512) that execute instructions stored in a memory (e.g. in memory 514) or stored in another computer-readable medium. The instructions, when executed, cause the inventory allocation engine 350 to perform the operations of inventory allocation engine described herein. Alternatively, some or all of the carbon offset predictor 204 may be implemented using dedicated circuitry, such as an application specific integrated circuit (ASIC), a graphics processing unit (GPU), or a programmed field programmable gate array (FPGA). In some embodiments, the inventory allocation engine 350 and/or the memory memory 524 may be located externally to the e-commerce platform 100. In some embodiments, the memory 524 may be part of the inventory allocation engine 350.

For simplicity, FIG. 6 illustrates and will be described in the context of supplier data 310 associated with a single supplier, and retailer data 320 associated with a single retailer. However, it should be understood that multiple suppliers and multiple retailers may make use of the e-commerce platform 100, and there may be multiple sets of supplier data 310 and multiple sets of retailer data 320 managed on the e-commerce platform 100. The retailer data 320 may include data for a single online store 138 associated with a retailer, may include data for multiple online stores 138 associated with a single retailer, or may include data for multiple online stores 138 associated with multiple retailers, among other variations. Similarly, the supplier data 310 may include data for a single supplier or for multiple suppliers.

The supplier data 310 includes inventory data 312 and allocation criteria 314. The supplier's inventory data 312 includes, for example, information about each product (e.g., product identifier such as SKU number) including the unit count of each product at respective different warehouses, across the network of warehouses managed using the e-commerce platform 100. The inventory data 312 may also include indication of which warehouses are being used by the supplier, for example if the supplier is not using all possible warehouses in the network of warehouses. Warehouses may be identified in the inventory data 312 by warehouse identifiers, or by geographic location/region, for example. The inventory data 312 may further include information about location of product within each warehouse (e.g., to facilitate picking of product within each warehouse). The supplier's allocation criteria 314 defines one or more supplier-specified criteria for allocation of product across the network of warehouses. The allocation criteria 314 may include, for example, prioritization of reduced shipping time, prioritization of reduced shipping price, prioritization of reduced carbon footprint, ensuring a minimum number of products at a warehouse, limiting a maximum number of products at a warehouse among other possibilities, and may be a combination of criteria. The allocation criteria 314 may be used for determining how the supplier's products should be automatically allocated across different warehouses, as discussed further below.

The retailer data 320 includes inventory data 322 and allocation criteria 324. The retailer's inventory data 322 and allocation criteria 324 may be similar to the supplier's inventory data 312 and the supplier's allocation criteria 314 and need not be described again in detail. The retailer data 320 also includes marketing data 326, customer data 328 and sales data 330.

The marketing data 326 may include, for example, defined parameters for current or future marketing campaigns. Parameters defined for a given current or future marketing campaign may include, for example, a target demographic (e.g., target age group, target gender, target geographic region, etc.), marketing content (e.g., message content, promotions, etc.), marketing schedule (e.g., duration of campaign, planned phases of the campaign, etc.), distribution channel (e.g., via email, via social media, etc.), among other possible parameters. The parameters for a given marketing campaign may be provided to a marketing engine 340 of the e-commerce platform 100. The marketing engine 340 may then be used to conduct the marketing campaign according to the defined parameters. In some examples, the marketing engine 340 may also provide output that may be added to or used to update the marketing data 326. For example, the marketing engine 340 may recommend default parameter values that may be used by a retailer to define a marketing campaign in the retailer's marketing data 326.

The customer data 328 may include information that is collected and stored by the retailer about the retailer's customers. For example, the customer data 328 may include information about existing customers, customers who have previously made purchases from the retailer, customers who have opted in to join the retailer's customer list, customers who have subscribed to communications from the retailer, or any other customer who have some relationship with the retailer. The customer data 328 may include information about a customer's name, geographic location (e.g., shipping address), contact information (e.g., email address), shopping preferences, or other data that a customer consents to sharing with the retailer. For privacy reasons, the customer data 328 may not be shared by the retailer with other service providers without explicit customer consent.

The sales data 330 may include information that is collected and stored by the retailer about sales of products offered by the retailer. The sales data 330 may include data about historical sales (e.g., sales over previous years, previous months, previous weeks, or previous days), as well as real-time or near real-time sales data. The sales data 330 may be broken down by individual physical or online stores associated with the retailer, geographic location/region of sales (e.g., based on shipping addresses of customers and/or based on location of physical stores), temporal aspect (e.g., sales by season, sales by month, sales by day of the week, etc.), among other possibilities. In some examples, the retailer may perform analysis of the sales data 330 (e.g., using the analytics facility 132 provided by the e-commerce platform 100, or using some other third-party service) and the results of the analysis (e.g., identified sales trends) may also be stored in the sales data 330.

In some examples, the supplier data 310 may include the supplier's marketing data, customer data and sales data, similar to that described above for the retailer data 320.

As previously mentioned, the supplier and the retailer may both use the same e-commerce platform 100 or same inventory allocation engine 350 to manage inventory, and the same network of physical warehouses to store inventory. Instead of the supplier shipping products to the retailer, the purchased products can be simply allocated from the supplier to the retailer within a warehouse. The allocation of products from the supplier to the retailer may be managed by the e-commerce platform 100, without the supplier or retailer being aware of how the allocation is done.

In the example of FIG. 6, the e-commerce platform 100 includes the inventory allocation engine 350 to manage allocation of inventory between the supplier and the retailer. When a retailer completes an order for a certain total number of units of a product, the inventory allocation engine 350 may be called (e.g., by the core commerce facility 136 (see FIG. 1)) to fulfill the order by automatically allocating the required number of units from the supplier to the retailer. The inventory allocation engine 350 updates the supplier's inventory data 312 by decreasing the count of the product by the ordered total number and updates the retailer's inventory data 312 by increasing the count of the product by the ordered total number.

In particular, because the supplier and the retailer use the same network of warehouses which in this example is managed by the e-commerce platform 100, the inventory allocation engine 350 is able to allocate inventory from the supplier to the retailer within the same warehouse, so that no product needs to be physically shipped from the supplier to the retailer. In some examples, there may be physical movement of product within the warehouse (e.g., from the supplier's physical shelf to the retailer's physical shelf), but such movement of product is relatively quick and inexpensive compared to shipping of product out of the warehouse.

Further, the inventory allocation engine 350 manages allocation of product from the supplier to the retailer across multiple warehouses where the ordered product is stored. The supplier may have products stored across different warehouses at different geographic regions. The retailer may also store product at warehouses in different geographic regions. At least some of the warehouses used by the supplier may be the same as at least some of those used by the retailer. The inventory allocation engine 350 thus can allocate inventory from the supplier to the retailer over different warehouses. That is, to fulfill an order for a total number of units of a product, numbers of units can be allocated to the retailer from different warehouses. The inventory allocation engine 350 updates the supplier's inventory data 312 to decrease respective unit counts associated with different warehouses by respective numbers of units, and updates the retailer's inventory data 322 to increase the unit counts at the warehouses by the corresponding number of units. Spreading allocation of product across different warehouses may help to ensure that the supplier's inventory is not depleted at any one region (so that the supplier remains able to satisfy orders by other retailers). Further, different numbers of units can be allocated to the retailer from warehouses at different geographic regions.

For example, a retailer may specify how an order should be allocated geographically (e.g., if the retailer knows or anticipates a greater demand at a first region compared to a second region). In the present disclosure, the term “geographic allocation” will be used to refer to the allocation of products from a supplier to a retailer across different warehouses at different geographic regions. Allocation of products may involve updating the supplier's inventory data and the retailer's inventory data, associated with warehouses at different geographic regions, to reflect how different numbers of units have been allocated from the supplier to the retailer at the corresponding warehouses. Geographic allocation may include allocation of different numbers of units of product from the supplier to the retailer, at respective different warehouses, to fulfill a retailer's order for a total number of units (i.e., the numbers of units allocated across all the different warehouses sum up to the total number ordered). A retailer-specified geographic allocation may be provided when the retailer completes the order for the products. Alternatively or additionally, geographic allocation may be determined by the inventory allocation engine 350 based on the retailer's allocation criteria 324. For example, the allocation criteria 324 may specify that orders should always be evenly divided across all of the warehouses used by the retailer. In some examples, if the retailer does not specify how ordered products should be allocated geographically, the inventory allocation engine 350 may allocate products from the supplier to the retailer across different warehouses according to some default allocation criteria. For example, the inventory allocation engine 350 may allocate product equally across different warehouses by default, or may allocate product according to the supplier's allocation criteria 314.

Alternatively or additionally, the inventory allocation engine 350 may allocate product across different warehouses based on historical or predicted geographic demand. The inventory allocation engine 350 may use information from the analytics facility 132, retailer data 320 and/or supplier data 310 to determine historical or predicted geographic demand, as discussed further below, and allocate product accordingly. If a retailer provided retailer-specified geographic allocation and the inventory allocation engine 350 determines a different allocation of product, the inventory allocation engine 350 may generate a notification to the retailer (e.g., notification provided to the retailer device 102) that a different geographic allocation is recommended. The retailer may be provided with an option to accept the recommended geographic allocation of product, or to maintain the retailer-specified geographic allocation.

The inventory allocation engine 350 may extract information about historical or predicted sales from the retailer data 320 (e.g., the retailer may consent to access to the retailer's sales data 330 by the inventory allocation engine 350). For example, the retailer's sales data 330 may include information identifying historical or predicted sales trends at different geographic regions (e.g., sales by physical stores at different locations and/or shipments to customers in different regions). The inventory allocation engine 350 may receive, from the analytics facility 132, analysis of sales (of the same or similar product) by that retailer or by multiple retailers. For example, the data facility 134 may store aggregated data about sales of the same product, related product, similar product or product category, from all retailers using the e-commerce platform 100. The analytics facility 132 may identify, from the retailer's own sales data 330 and/or from aggregated data in the data facility 134, historical sales trends based on geography, and provide this information to the inventory allocation engine 350.

Analysis of historical sales (e.g., by the analytics facility 132 using analytical algorithms such as machine-learned algorithms or classical algorithms) can identify general geographic patterns (e.g., product sells more at a first geographic region compared to a second geographic region), seasonal patterns (e.g., sales at a given geographic region increases in the summer), demographic patterns (e.g., product sells more in regions with younger population, which can be cross-referenced with known demographic spread, such as based on public statistic), among other possible trends. The analytics facility 134 may use analysis of historical sales to generate predicted sales at different geographic regions.

The inventory allocation engine 350 may then automatically allocate product from the supplier to the retailer such that a larger proportion of the retailer's order is allocated to a region having greater historical or projected/predicted sales, compared to another region having lower historical or projected/predicted sales.

The inventory allocation engine 350 may also allocate product based on current or future marketing by the retailer (e.g., based on the retailer's marketing data 326 or based on marketing campaign parameters submitted by the retailer to the marketing engine 340), on the basis that sales are expected to increase in regions targeted by the marketing. For example, if the retailer has set up a current or future marketing campaign or flash sale for the product, the inventory allocation engine 350 may use parameters of the marketing campaign or flash sale to identify geographic regions that are likely to have higher sales. For example, the parameters may specify a geographic target of the marketing (and hence sales at that geographic region is likely to have higher sales), or demographic target of the marketing (which may be cross-referenced with known demographic spread to identify regions with likely increased sales), among other possibilities. Similarly, the inventory allocation engine 350 may allocate product based on current or future marketing by the supplier (e.g., based on the supplier's marketing data or based on marketing campaign parameters submitted by the supplier to the marketing engine 340).

In some examples, the analytics facility 132 may analyze current or planned marketing activities (e.g., by analyzing marketing data from multiple retailers and/or suppliers, or analyzing aggregated marketing data stored in the data facility 134) across multiple retailers on the e-commerce platform 100 (e.g., multiple retailers selling the same product, related product or similar product, or a product in the same product category) to identify marketing trends and provide this information to the inventory allocation engine 350. The inventory allocation engine 350 may then allocate product based on this analysis.

Analysis of consumers' activity (other than sales) may also be performed to determine geographic demand. In the present disclosure, the term “geographic demand” may refer to demand for a product in different geographic regions, including demand that varies between regions. A geographic region may range in size from a local neighborhood (e.g., a few streets), a municipality (e.g., a city or town), a state or province within a country, to a country, for example. For example, various online activity on the e-commerce platform 100 (e.g., searching for products, viewing product pages, viewing product reviews, etc.) may be analyzed in the aggregate (e.g., by the analytics facility 132) to identify geographic trends in consumer interest in a product or product category. This analysis may be used by the inventory allocation engine 350 to allocate product accordingly. For example, if analysis of online product searches indicate that there are more searches for a given product in New York compared to Florida, the inventory allocation engine 350 may fulfill a retailer's order for the given product by allocating 80% of the ordered units from the supplier to the retailer at a warehouse in the New York region and allocating 20% of the ordered units from the supplier to the retailer at a warehouse in the Florida region.

It should be understood that other techniques and analysis may be performed by the e-commerce platform 100 to determine geographic demand and allocate product accordingly.

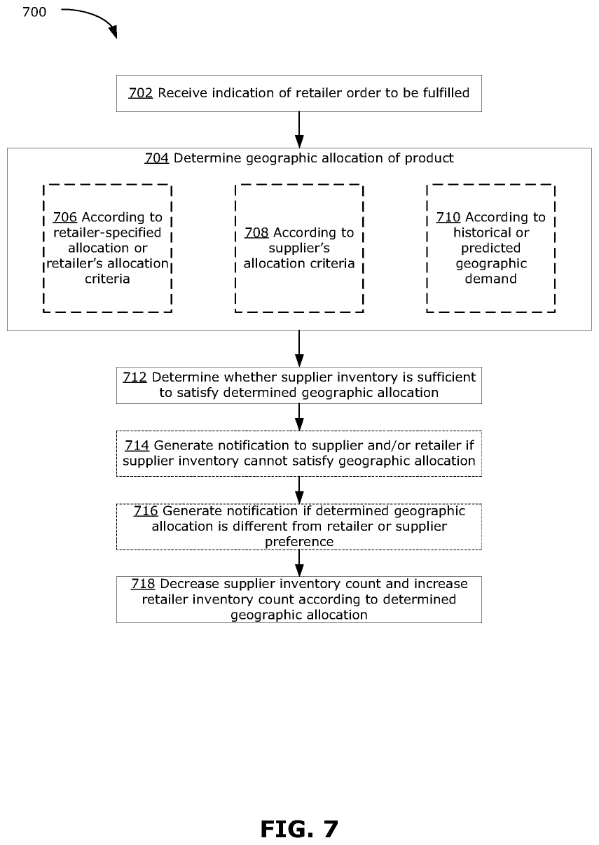

FIG. 7 is a flowchart illustrating an example method 700 for geographic allocation of product from a supplier to a retailer, across different warehouses at different geographic regions. The example method 700 may be performed by the e-commerce platform 100, for example using the inventory allocation engine 350.

At operation 702, an indication of a retailer's order that needs to be fulfilled is received. The retailer order includes a total number of units of a product that the retailer ordered from the supplier. The retailer order may optionally include a retailer-specified geographic allocation for the products. The retailer-specified geographic allocation may specify how the order should be proportionally allocated across different regions (e.g., 20% of the order should be allocated to warehouse at region A and 80% of the order should be allocated to warehouse at region B), may specify how the order should be allocated in absolute numbers (e.g., 80 units should be allocated to warehouse at region A and 20 units should be allocated to warehouse at region B), may specify a minimum allocation at different warehouses (e.g., minimum 5 units should be allocated to all warehouses used by the retailer), among other possibilities.

At operation 704, the inventory allocation engine 350 determines a geographic allocation of the product, to fulfill the total number ordered. As depicted in FIG. 7 through the use of stippled lines, one or more optional operations may be employed, alone or in combination, in order to determine the geographic allocation. More particularly, as shown in FIG. 7, the geographic allocation may be determined at the operation 704, for example, by employing one or more of the operations 706, 708 and/or 710 further described below.

For example, at operation 706, the inventory allocation engine 350 determines the retailer-specified allocation (e.g., if included in the retailer's order) or the retailer's allocation criteria 324. If the retailer-specified allocation is included in the retailer's order, the inventory allocation engine 350 may simply allocate product according to the retailer-specific allocation. If there is no retailer-specified allocation included in the order, the inventory allocation engine 350 may geographically allocate product according to the retailer's allocation criteria 324.

The retailer's allocation criteria 324 may, for example, define one or more factors to be prioritized or taken into consideration for determining geographic allocation. A retailer might specify priorities that are affected by the geographical location of inventory, such as shipping time, shipping price, or carbon emissions, among other possibilities. The inventory allocation engine 350 may calculate how well each warehouse satisfies the retailer's allocation criteria 324, using defined equations that assign prioritization weights according to how the retailer prioritizes different factors. For example, if the retailer's allocation criteria 324 specifies that reducing carbon emissions is the highest priority, reducing transportation cost is the second highest priority and the reduction of shipping time is third highest priority, then the inventory allocation engine 350 may assign a prioritization weight of 3 for carbon emissions, a prioritization weight of 2 for transportation cost, and a prioritization weight of 1 for shipping time. The inventory allocation engine 350 may calculate, for a given warehouse at a given geographic location, the average carbon emission for shipping product to the retailer's list of customers from this warehouse, the average transportation cost for shipping product to the retailer's list of customers from this warehouse, and the average shipping time for shipping product to the retailer's list of customers from this warehouse. Prioritization weights may be applied to each calculated result according to priority, and then the weighted results are summed up, to arrive at a metric for the given warehouse. After performing a similar calculation for all warehouses used by the retailer, the inventory allocation engine 350 may rank the warehouses according to the respective calculated metrics. Product may then be allocated across the warehouses according to their respective ranking, or according to their respective metric. Other techniques may be used by the inventory allocation engine 350 to account for the retailer's allocation criteria. The result is that the allocation may not be simply based on reducing geographic distance to the retailer's customers. For example, if carbon footprint is prioritized over shipping time, more units of a product may be allocated to a warehouse that is close to a train station (thus having a lower carbon footprint for transporting the product) over another warehouse that would be quicker to ship to the retailer's consumers but requiring air transportation (thus having a higher carbon footprint). In another example, if shipping price is prioritized over shipping time, more product may be allocated to a warehouse that is farther away from consumers but associated with lower transportation costs.

In another example, at operation 708, the inventory allocation engine 350 may geographically allocate product according to the supplier's allocation criteria 314. This may be performed in a similar manner to that described above for the retailer's allocation criteria 324. The supplier's allocation criteria 314 may be taken into account only after considering the retailer-specified allocation (if any) and the retailer's allocation criteria 324 (if any). In the event that there is a conflict between the supplier's allocation criteria 314 and the retailer-specified allocation or the retailer's allocation criteria 324, the retailer's preferences may take priority. Other ways of resolving a conflict may be used.

In another example, at operation 710, the inventory allocation engine 350 may geographically allocate product according to historical or predicted geographic demand. For example, as discussed previously, the inventory allocation engine 350 may use information from the analytics facility 132, from the retailer's marketing data 326, from the supplier's marketing data, from the retailer's sales data 330, or from the retailer's customer data 328, among other possibilities, to determine historical or projected/predicted geographic demand for the product. The inventory allocation engine 350 may then allocate a larger number of product to warehouse(s) at region(s) where historical or projected/predicted demand is higher. The allocation according to historical or predicted geographic demand may be performed only after considering the retailer-specified allocation (if any), the retailer's allocation criteria 324 (if any), and the supplier's allocation criteria 314 (if any). In some examples, the allocation according to historical or predicted geographic demand may be performed independently of the retailer-specified allocation (if any), the retailer's allocation criteria 324 (if any), and the supplier's allocation criteria 314 (if any). If there is a conflict between the allocation according to historical or predicted demand and any retailer or supplier preference, a notification may be generated (e.g., at operation 716 described below).

Example operations 706, 708, 710 illustrate some techniques by which the inventory allocation engine 350 may determine a geographic allocation of product to fulfill the retailer's total ordered number of units. The operations 706, 708, 710 may be performed separately or in any combination. It should be understood that other techniques may be used, in addition to or instead of the operations 706, 708, 710. For example, there may be other considerations for determining the geographic allocation, such as which warehouses are being used by both the supplier and the retailer (e.g., in some cases where the retailer might not make use of all warehouses in the network of warehouses managed by the e-commerce platform 100).

However the operation 704 is implemented, following the operation 704, the method 700 proceeds to operation 712.

At operation 712, the inventory allocation engine 350 determines whether the supplier's inventory is sufficient to satisfy the determined geographic allocation. For example, the inventor allocation engine 350 may check the supplier's inventory data 312 to determine whether the supplier has sufficient numbers of units across the different warehouses to satisfy the determined geographic allocation of products from the supplier to the retailer. Notably, even if the supplier's total inventory is sufficient to fulfill the retailer's order, the geographic distribution of the supplier's inventory (i.e., the numbers of units of the product the supplier has stored in different warehouses at different regions) may not be sufficient to satisfy the determined geographic allocation.

Optionally, at operation 714, if the supplier's inventory is not sufficient to satisfy the determined geographic allocation, a notification may be generated to the supplier and/or the retailer (e.g., provided to the supplier device 160 and/or retailer device 102). The notification to the supplier may, for example, provide the supplier with information to adjust how the supplier's inventory should be geographically distributed. The notification to the retailer may, for example, provide the retailer with information to adjust the retailer's specified geographic allocation (if provided with the retailer's order).

Optionally, if the supplier's inventory is not sufficient to satisfy the determined geographic allocation, the determined geographic allocation may be adjusted so that the geographic allocation can be met by the supplier. In some examples, operation 712 may take place together with operation 704, or operation 712 may loop back to operation 704 (e.g., in an iterative manner) until a geographic allocation is arrived at that can be met by the supplier and that also (as much as possible) takes into consideration the retailer-specified allocation (if any), the retailer's allocation criteria (if any), the supplier's allocation criteria (if any), and historical or predicted geographic demand for the product. If the determined geographic allocation can be adjusted to be met by the supplier's inventory, it may not be necessary to notify the supplier and/or retailer and operation 714 may be omitted.

Optionally, at operation 716, if the determination of geographic allocation at operation 704 was performed based on other considerations (e.g., based on historical or projected/predicted geographic demand) instead of (or in addition to) the retailer-specified allocation included in the retailer's order or the retailer's allocation criteria 324, and the determined geographic allocation is different from the retailer's order or the retailer's allocation criteria 324, then a notification may be generated (e.g., provided to the retailer device 102) to notify the retailer. The notification may include an option for the retailer to accept or reject the determined geographic allocation. The notification may indicate that the determined geographic allocation is recommended, for example based on historical or predicted geographic demand. If the determined geographic allocation is rejected, the method 700 may return to operation 704 to determine the geographic allocation again based only on the retailer-specified allocation included in the retailer's order or the retailer's allocation criteria 324. A notification may also be generated (e.g., provided to the supplier device 160) to notify the supplier if the determined geographic allocation is different from the supplier's allocation criteria 314. The notification to the supplier may include a reason why the determined geographic allocation is different from the supplier's allocation criteria 314 (e.g., because the retailer specified a different geographic allocation). The notification to the supplier may not include an option to reject the determined geographic allocation, so that the supplier may not override the retailer's preference (e.g., the retailer's preference may take priority over the supplier's preference).

At operation 718, the retailer's order is fulfilled according to the determined geographic allocation. This may be performed by updating the supplier's inventory data 312 and the retailer's inventory data 322 according to the determined geographic allocation. In the supplier's inventory data 312, the unit count associated with each respective warehouse is decreased by the determined respective numbers of units. In the retailer's inventory data 322, the unit count associated with each respective warehouse is correspondingly increased by the determined respective numbers of units.

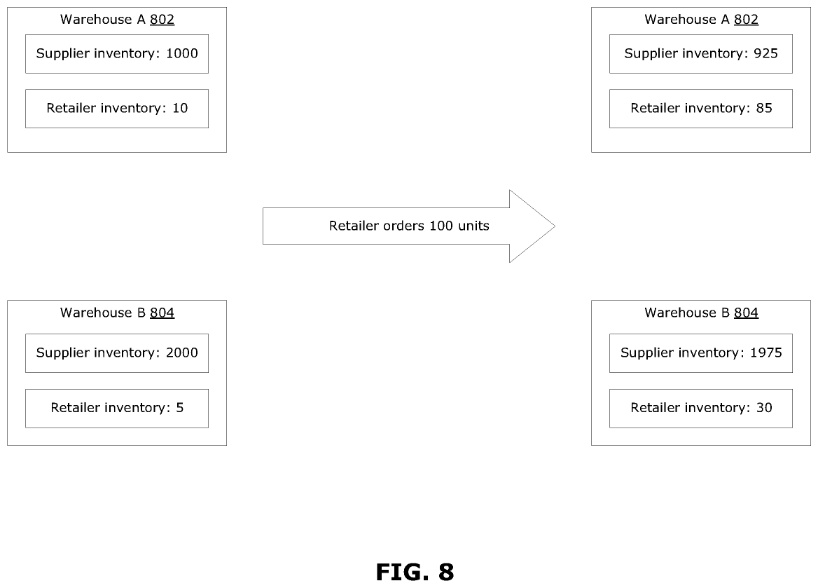

FIG. 8 illustrates an example of how a retailer's order can be fulfilled by allocating products over warehouses at different geographic regions, for example using the method 700. FIG. 8 shows a simplified scenario where a network of warehouses includes warehouse A 802 in a first geographic region and warehouse B 804 in a second geographic region. The warehouses 802, 804 store product (e.g., necklaces) for both the supplier and the retailer, as shown in the unit counts in FIG. 8.

Initially, the supplier has 1000 units of the necklaces stored at warehouse A 802 and 2000 units stored at warehouse B 804; and the retailer has 10 units of the necklaces stored at warehouse A 802 and 5 units stored at warehouse B 804. Using the e-commerce platform 100, the retailer completes an order for 100 units of the supplier's necklaces. The retailer's order does not specify any geographic allocation for the order. The inventory allocation engine 350 determines (e.g., based on the geographic distribution of the retailer's customers (determined from the customer data 328) or based on the geographic distribution of the retailer's historical sales (determined from the sales data 330)) that 75 units of the necklaces should be allocated to warehouse A 802 and 25 units of the necklaces should be allocated to warehouse B 804. The inventory allocation engine 350 automatically updates the supplier's inventory data 312 and the retailer's inventory data 324 accordingly, to fulfill the retailer's order. In this example, the supplier's unit count is decreased to 925 at warehouse A 802 and decreased to 1975 at warehouse B 804; and the retailer's unit count is increased to 85 at warehouse A 802 and increased to 30 units at warehouse B 804.

The example in FIG. 8 illustrates how inventory may be automatically allocated from a supplier to a retailer, across different warehouses in a network of warehouses. Product does not need to be physically shipped from the supplier to the retailer. Product may be allocated in different numbers at different warehouses, so that a retailer's order may be fulfilled in a way that better suits the geographic preference or demand of the retailer. This geographic allocation may be automatic and transparent to the supplier and the retailer. Allocation of product in this way may help to reduce costs associated with movement of shipping of product from supplier to retailer, and from retailer to end customers.

In some examples, after product has been allocated from the supplier to the retailer, reallocation of product may be performed. In the present disclosure, the term “allocation” may refer to the initial assigning of products from the supplier to the retailer, to fulfill a retailer's order. The term “reallocation” may refer to reassigning of products for an already-fulfilled order. Reallocation involves modifying the numbers of units of products that have been allocated from the supplier to the retailer, across different warehouses, without changing the total number of units. Reallocation may take place in response to changes in actual or predicted geographic demand, for example.

For example, the inventory allocation engine 350 may continuously (e.g., in real-time or near real-time), periodically (e.g., daily) or intermittently obtain updated information to determine updated geographic demand. For example, any of the information described above for determining geographic allocation (e.g., at operation 704 of the method 700) may be updated and provided to the inventory allocation engine 350 to determine an updated geographic demand. The inventory allocation engine 350 may request or retrieve the updated information (e.g., from the analytics facility 132, from the supplier data 310 and/or from the retailer data 320), or the updated information may be pushed to the inventory allocation engine 350. The updated information may indicate that the geographic allocation that was performed initially to fulfill the order should be modified. For example, actual geographic demand (e.g., as recorded in the sales data 330) may not match historical or predicted geographic trends; the retailer may launch a new marketing campaign or flash sale (e.g., indicated in the marketing data 326 or in marketing parameters outputted by the marketing engine 340) with a new geographic target; or there may be change in geographically-specific online activity on the e-commerce platform 100 (e.g., the analytics facility 132 finds there is a sudden surge in searches for the product from a particular geographic region).

Such changes in geographic demand may occur after a retailer's order has already been fulfilled (e.g., using the method 700 described above). In order to adjust to the updated geographic demand, reallocation of units to the retailer should be performed. Reallocation can be performed at regular intervals (e.g., daily, weekly, monthly), in response to a request from a supplier or retailer (e.g., requested by a supplier or retailer via a web portal provided by the e-commerce platform 100), or in real-time (or near real-time) as geographic demand changes.

Various events (including real-time events) may trigger reallocation of product from the supplier to the retailer. For example, initiation of a new marketing campaign by the retailer, or change in existing marketing campaign by the retailer (e.g., indicated in the marketing data 326 or in marketing parameters outputted by the marketing engine 340) may be detected by the inventory allocation engine 350 in real-time and trigger reallocation of product. In another example, increase or decrease of actual sales (e.g., as recorded in the sales data 330) at a region beyond a defined threshold (e.g., 20% higher or 20% lower than usual) may be detected by the inventory allocation engine 350 in real-time and trigger reallocation of product. In another example, actual inventory levels at a warehouse (e.g., as recorded in the retailer's inventory data 322) higher than a defined maximum or lower than a defined minimum may be detected by the inventory allocation engine 350 in real-time and trigger reallocation of product. In another example, increase or decrease in consumer online activity (e.g., detected by the analytics facility 132) beyond a defined threshold (e.g., 20% higher number of product searches over the day) may trigger real-time reallocation of product. In another example, sales across different geographic regions may be mismatched (e.g., beyond a defined margin of error) with the geographic allocation of product, which may be detected by the inventory allocation engine 350 in real-time and trigger reallocation of product. Other such events may be detected by the inventory allocation engine 350 to trigger reallocation of product, including combinations of events (e.g., inventory drops below a defined minimum at a region that also shows an increase in sales).

The inventory allocation engine 350 may perform reallocation of product as a real-time response to events. Real-time reallocation may enable customers or retail representatives to be provided with the best possible estimate of shipping time and cost. For example, responsive to a consumer (e.g., using a consumer device 150) or retail representative (e.g., using a POS device 152) selecting product to put in a virtual cart or for checkout, the inventory allocation engine 350 may perform real-time reallocation so that inventory is reallocated to a warehouse that provides the best shipping time and cost. In another example, if a sequence of consumer orders in the same region arrive in quick succession, inventory at a particular warehouse in that region may become quickly depleted. The inventory allocation engine 350 may detect this drop in inventory together with this increase in sales activity, and perform real-time reallocation so that inventory at that region is replenished. This enables later consumer orders in the same region to be provided with shipping time estimates and shipping cost estimates that are the same as (or similar to) that of earlier consumer orders in that region. An advantage of real-time reallocation is that the best shipping time and cost estimates can be provided for a consumer order in real-time, which encourages a consumer to complete an order. The inventory is reallocated by the inventory allocation engine 350 in real-time so that the order can be processed immediately after receiving the order, without any delay to manually reallocate units. As will be appreciated, such real-time reallocation requires sophisticated and detailed monitoring of events (e.g., all possible consumer activity on the e-commerce platform 100), and real-time responsiveness (e.g., in the time between a consumer starts places a product into a virtual cart and the time a consumer requests an estimate of the shipping price, which could be only a few seconds apart). The level of inventory management as disclosed herein is typically not possible using conventional systems that rely on human intervention. Put differently, the use of a computer is required. Indeed, if one were instead to attempt this using conventional manual methods, or even semi-manual (e.g., with computer assistance) methods, it would be practically impossible to be able to track changes in product demand/sales in real-time sufficiently fast to enable products to be reallocated between the time a consumer places the product in a virtual cart and the time the consumer requests a shipping estimate. Put another way, absent real-time or near-real time implementation using a computer, it may not be possible to process all orders.

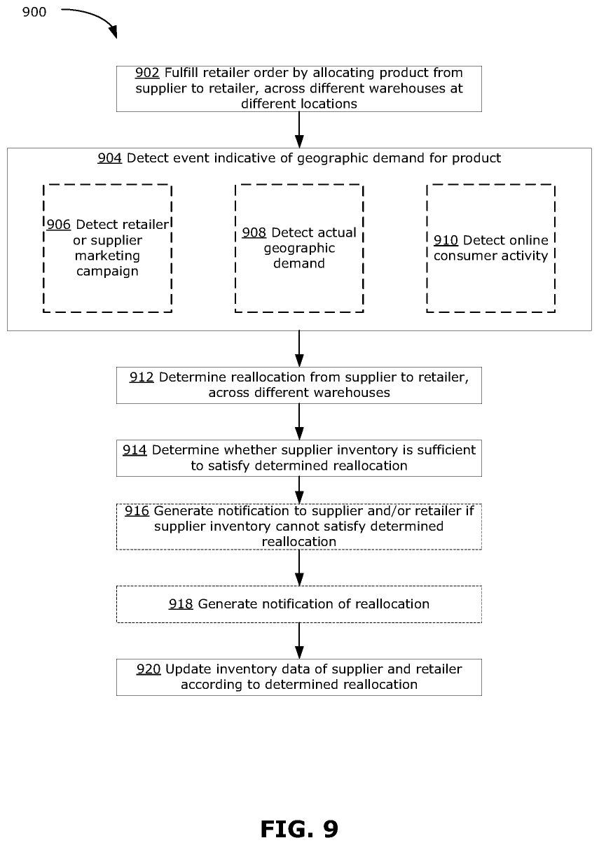

FIG. 9 is a flowchart illustrating an example method 900 for reallocating product from a supplier to a retailer, across different warehouses at different regions. The example method 900 may be performed by the e-commerce platform 100, for example using the inventory allocation engine 350.

At operation 902, a retailer's order for a total number of units of a product is received and fulfilled, by allocating product from the supplier to the retailer, across different warehouses at different regions. The geographic allocation may be performed using the method 700 described above, for example.

At operation 904, an event indicative of geographic demand for the product is detected. In particular, the event may be detected in real-time, and may indicate increased demand for the product at a particular geographic region. Conversely, the event may indicate decreased demand for the product at a particular geographic region. For simplicity, the following discussion will be the context of a detected event indicating increased demand for the product at a particular geographic region. As depicted in FIG. 9 through the use of stippled lines, one or more optional operations may be employed, alone or in combination, in order to detect an event indicative of geographic demand for the product. More particularly, as shown in FIG. 9, the geographic allocation may be determined at the operation 904, for example, by employing one or more of the operations 906, 908 and/or 910 further described below.

For example, at operation 906, the inventory allocation engine 350 may detect a retailer or supplier marketing campaign has been initiated (e.g., based on the retailer's marketing data 326, the supplier's marketing data, or information from the marketing engine 340). The inventory allocation engine 350 may further identify a geographic region that is a target of the marketing campaign and detect this as an event that is indicative of increased future demand at that geographic region, as discussed previously.

In another example, at operation 908, the inventory allocation engine 350 may detect actual geographic demand. For example, the retailer's sales data 330 may indicate increased sales in a first geographic region compared to a second geographic region, for example increased sales that exceed predicted or expected sales by a predefined margin. In another example, the retailer's inventory data 322 may indicate inventory being more depleted in a first geographic region compared to a second geographic region, where such depletion is considered to indicate greater demand for the product in the first geographic region.

In another example, at operation 910, the inventory allocation engine 350 may detect online consumer activity (e.g., via output from the analytics facility 132), which may be indicative of greater predicted demand at a first geographic region. The online consumer activity detected at the operation 910 may include online activity other than online purchases of the product. That is, the detected online consumer activity may include activities that may not be directly related to actual sales of a product. In some examples, the detected online consumer activity may indicate aggregated demand across multiple retailers on the e-commerce platform 100. The detected online consumer activity may be related to another product in the same product category, or a related product. Some online consumer activity that may be detected as being indicative of geographic demand include, for example, a completed or in-process checkout, a product being placed in a virtual cart, a product being flagged as being liked by a consumer or placed in an online wishlist by a consumer, a webpage for the product being viewed, a marketing message for the product being viewed, submitting a question online about the product (e.g., via the product webpage, or via a chat or support functionality to the retailer), or an online review for the product being viewed, among other possibilities.

The inventory allocation engine 350 may store defined demand weights for different types of online activity. Different demand weights may be assigned to different types of online consumer activity, to reflect how strongly or weakly a given activity correlates with an actual sale. For example, if a demand weight of “1” is the highest value (e.g., correlating with actual sale of one unit of the product), an activity that is strongly correlated with an actual sale (e.g., completed or in-process checkout) may be assigned a demand weight of 1 and an activity that is weakly correlated with an actual sale (e.g., viewing a product webpage or viewing a marketing message) may be assigned a demand weight of 0.001. It should be appreciated that there can be a range of demand weight values in between, which may capture different degrees of interest or commitment to a purchase. For example, the demand weight may be assigned in such a way that older events are discounted (e.g., placing a product in a virtual cart two days ago (without completing the purchase) is assigned a lower demand weight than placing a product in a virtual cart one hour ago). Different demand weights may be assigned at different stages of completing a checkout, for example one demand weight may be assigned when the consumer has entered a shipping address but not payment information, a higher demand weight may be assigned when the payment information has been entered, and a yet demand higher weight may be assigned when the order is finally submitted. Different demand weights may be assigned to the same online activity performed by different types of consumers. For example, online activity by a consumer who has previously purchased products from this retailer may be assigned a higher demand weight than the same activity by a consumer who has no previous relationship with this retailer. Other such variations may be possible. Generally, the demand weight that is assigned to a given online consumer activity may be defined to reflect the historical sale conversion rate for the activity.

Example operations 906, 908, 910 illustrate some techniques by which the inventory allocation engine 350 may detect an event indicative of geographic demand for a product. The operations 906, 908, 910 may be performed separately or in any combination. It should be understood that other techniques may be used, in addition to or instead of the operations 906, 908, 910. For example, a drop in inventory levels (e.g., below a defined minimum threshold) at a given warehouse may indicate demand for the product in a geographic region where the given warehouse is located.

However the operation 904 is implemented, following the operation 904, the method 900 proceeds to operation 912.

At operation 912, a reallocation of units of the product, from the supplier to the retailer, is determined. The reallocation of units is determined based on the geographic demand indicated by the event detected at operation 904. At previous operation 904, an event is detected that indicates increased demand for the product at a particular geographic region, or decreased demand for the product at a particular geographic region. In particular, the detected event may indicate a demand for the product at the particular geographic region that does not match well with the number of units of the product allocated to the warehouse (at operation 902) in that geographic region. For example, if a small number of units of the products was allocated to a first geographic region at operation 902, but a detected event at operation 904 indicates high demand for the product in the first geographic region, the inventory allocation engine 350 may determine that there is a mismatch between the initial geographic allocation and the indicated geographic demand. If there is no mismatch between the geographic allocation and the indicated geographic demand, then the method 900 may end. Alternatively, the method 900 may loop back to the operation 904 to continue monitoring events.

When reallocation is required, the inventory allocation engine 350 may determine the reallocation of units of the product between different warehouses in various ways. The technique used to determine reallocation may depend on the detected event at operation 904. For example, if the detected event is a retailer or supplier marketing campaign (at optional operation 906) that is targeted at a first geographic region, the inventory allocation engine 350 may calculate an expected sales conversion rate for the marketing campaign to determine the number of units of the product that should be stocked at the wares in the first geographic region, in anticipation of the expected geographic demand. In another example, if the detected event is detected online activity (at optional operation 910) at a first geographic region, applying the corresponding demand weight may convert the online activity to the expected sales conversion rate (e.g., a completed checkout has a demand weight of 1, corresponding to sales of 1 unit; whereas viewing a product webpage has a demand weight of 0.001, corresponding to sales of 1 unit per 1000 webpage views). Thus, by aggregating (e.g., summing) the weighted online activity, an estimation of the number of units to be reallocated may be obtained.

It should be appreciated that various calculations may be performed to convert determined geographic demand for a first geographic region to the number of units of the product that should be reallocated to the first geographic region. The number of units of the product that should be reallocated to the warehouse in the first geographic region must be reallocated away from one or more other warehouses in other geographic regions. Units may be reallocated from a warehouse in a second geographic region that has the lowest geographic demand, for example. Or units may be evenly reallocated from all other warehouses, in another example. Various techniques may be used to determine how the numbers of units of products at different warehouses should be adjusted for the reallocation. The present disclosure is not limited by how the specific numbers of units to be reallocated is determined.

Notably, reallocation involves not just adjusting the inventory data of the retailer between the warehouses used by the retailer, but also adjusting the inventory data of the supplier. That is, assuming that a supplier has enough inventory, reallocating more of the retailer's inventory to a first warehouse can be performed by allocating more of the supplier's inventory to the retailer at the first warehouse (and correspondingly reallocating the retailer's inventory away from a second warehouse can be performed by allocating some of the retailer's inventory back to the supplier at the second warehouse). This enables the retailer's inventory to be reallocated between different warehouses, without requiring physical movement of inventory between warehouses.

At operation 914, the inventory allocation engine 350 determines whether the supplier's inventory is sufficient to satisfy the determined reallocation. Operation 914 may be similar to operation 712 described previously, the details of which need not be repeated here.

Optionally, at operation 916, if the supplier's inventory is not sufficient to satisfy the determined reallocation, a notification may be generated to the supplier and/or the retailer (e.g., provided to the supplier device 160 and/or retailer device 102). Operation 916 may be similar to operation 714 described previously, the details of which need not be repeated here.

Optionally, if the supplier's inventory is not sufficient to satisfy the determined reallocation, the determined reallocation may be adjusted so that the reallocation can be met by the supplier. In some examples, operation 914 may take place together with operation 912, or operation 914 may loop back to operation 912 (e.g., in an iterative manner) until a reallocation is arrived at that can be met by the supplier and that also (as much as possible) takes into consideration the indicated geographic demand for the product. If the determined reallocation can be adjusted to be met by the supplier's inventory, it may not be necessary to notify the supplier and/or retailer and operation 916 may be omitted.

Optionally, at operation 918, a notification of the determined reallocation (after any adjustments, if applicable) may be generated to the supplier and/or the retailer (e.g., provided to the supplier device 160 and/or retailer device 102). The notification may provide an option for the supplier or retailer to accept or reject the determined reallocation. The notification may include information indicating why the reallocation was determined (e.g., information about the number of units being reallocated, information about the warehouses involved in the reallocation of units, information about the detected event indicating geographic demand, etc.). Information about the determined reallocation may be useful to the supplier and/or retailer, for example to help the supplier and/or retailer to plan how inventory should be managed in the future, or to plan future marketing.

In some examples, the inventory allocation engine 350 may require approval from both supplier and retailer before proceeding with the determined reallocation. In other examples, the inventory allocation engine 350 may require approval from only the supplier or only the retailer before proceeding with the determined reallocation. In some examples, the supplier and/or retailer may have an option (e.g., accessible via an administrator portal provided by the e-commerce platform 100) to enable or disable automatic approval of inventory reallocation by the inventory allocation engine 350. In examples where approval of inventory reallocation is not necessary or has been automatically enabled, the supplier and/or retailer may nonetheless be notified that a reallocation of inventory has taken place, including the details of the reallocation (e.g., number of units reallocated, warehouses involved in the reallocation, reason for the reallocation, etc.).

At operation 920, the inventory allocation engine 350 updates the supplier's inventory data 312 and the retailer's inventory data 322 according to the determined reallocation. In the supplier's inventory data 312, the unit count associated with each warehouse involved in the reallocation is adjusted (increased or decreased) by the determined number of units to be reallocated. In the retailer's inventory data 322, the unit count associated with each warehouse involved in the reallocation is also correspondingly adjusted (decreased or increased).

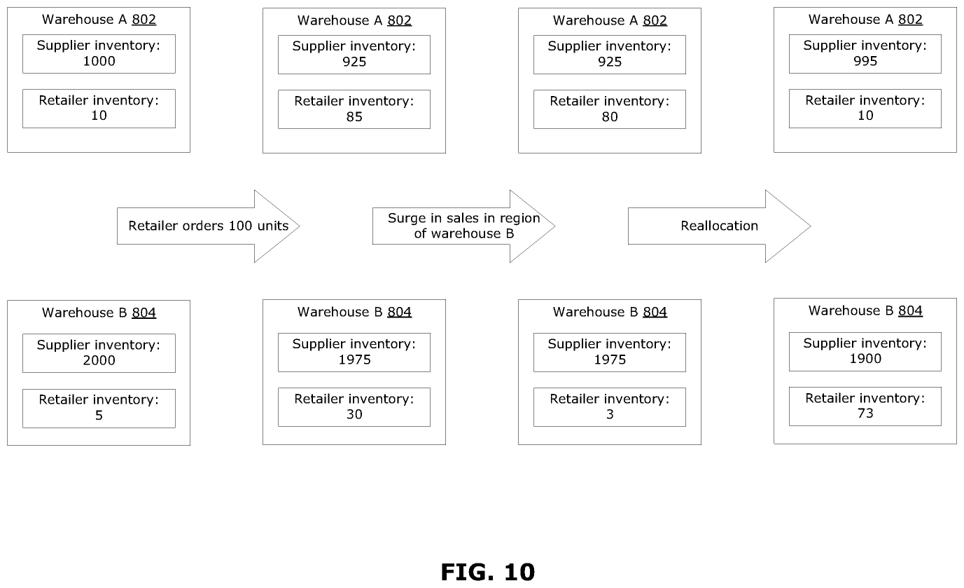

FIG. 10 illustrates an example of how a retailer's order can be fulfilled by allocating products over warehouses in different geographic regions, for example using the method 900. FIG. 10 shows a simplified scenario, similar to FIG. 8. Warehouse A 802 is in a first geographic region, and warehouse B 804 is in a second geographic region. The warehouses 802, 804 store product (e.g., necklaces) for both the supplier and the retailer, as indicated by the unit counts shown in FIG. 10.

As described above with respect to FIG. 8, the retailer's order of 100 units of necklaces may be fulfilled by initially allocating 75 units (out of a total of 100 units ordered) to warehouse A 802 and 25 units to warehouse B 804, and updating the supplier's and retailer's inventory data accordingly, as shown in FIG. 10.

Subsequently, an event is detected indicating a geographic demand. In this example, the detected event is an increase in actual sales (e.g., detected using the retailer's sales data) in the geographic region where warehouse B is located. In particular, the detected surge in actual sales indicates a geographic demand that is mismatched with the initial allocation. Due to the surge in sales, the retailer's inventory of necklaces at warehouse B 804 becomes depleted much faster than the inventory of necklaces at warehouse A 802 (e.g., the retailer's inventory of necklaces at warehouse B 804 drops down to only 3 units, while the retailer's inventory of necklaces at warehouse A 802 is at 80 units).

The inventory allocation engine 350 detects this surge in sales in real-time and reallocates the retailer's inventory so that the retailer's inventory is increased at warehouse B 804 (and the retailer's inventory is correspondingly decreased at warehouse A 802). In this example, 70 units of the necklaces are reallocated to warehouse B 804 from warehouse A 802. The reallocation is performed by reallocating 70 more units of the necklaces from the supplier to the retailer at warehouse B 804, and reallocating 70 units of necklaces from the retailer back to the supplier at warehouse A 802 (as shown by the updated inventory data in FIG. 10).

The above examples illustrate how a retailer's inventory may be automatically reallocated between warehouses, to adjust to geographic demand in real-time. In particular, little or no human intervention is required, with the result that the real-time reallocation can respond to real-time changes in geographic demand with very little latency. Conveniently, in this way, inventory may be allocated so as to allow orders to be fulfilled/processed that would otherwise not be possible with a non real-time/non near-real time system.

In various examples described herein, inventory between the supplier and the retailer is managed in such a way that product does not need to be physically shipped between warehouses. The inventory allocation engine is able to manage both the supplier's and the retailer's inventory in a way that involves little or no human intervention, in real-time.

Notably, transferring inventory between suppliers and retailers may allow a reduction in greenhouse gas emissions and/or other environmental benefits due to the avoidance/limiting of shipping/freight for inventory transfers. Put another way, applying the subject matter of the present application in a commercial context may help to resolve or mitigate environmental impacts and/or to conserve the natural environment or natural resources.

In various examples, the present disclosure describes systems and methods that enable detection of current or future geographic demand and reallocate inventory accordingly. For example, many different types of online activity may all be taken into account (e.g., in an anonymized or aggregated fashion) to indicate geographic demand and reallocate product accordingly.

In various examples, the present disclosure also enables a supplier's or retailer's planned marketing to be taken into account for geographically allocating or reallocating product, without the retailer having to intentionally and manually control the product allocation across different warehouses.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

All referenced documents are hereby incorporated by reference in their entireties.

1. A system comprising:
a processor in communication with storage, the processor configured to execute instructions from the storage to cause the system to:
receive, from a device associated with a retailer, an order for a total number of units of a product;
allocate the total number of units of the product to the retailer by:
in supplier inventory data associated with a supplier, decreasing unit counts associated with respective different warehouses in respective different geographic regions by respective numbers of units of the product; and
in retailer inventory data associated with the retailer, increasing unit counts associated with the respective different warehouses by the respective numbers of units of the product;
detect an event, the event being indicative of demand for the product at a first geographical region; and
responsive to detecting the event, reallocate a first number of units of the product to a first warehouse at the first geographic location from a second warehouse at a second geographic region by:
in the supplier inventory data, decreasing the unit count associated with the first warehouse by the first number of units and increasing the unit count associated with the second warehouse by the first number of units; and
in the retailer inventory data, increasing the unit count associated with the first warehouse by the first number of units and decreasing the unit count associated with the second warehouse by the first number of units.

2. The system of claim 1, wherein the event is detected in real-time, and wherein the processor is configured to execute the instructions to cause the system to perform the reallocating in real-time with occurrence of the event.

3. The system of claim 1, wherein the event is based on one or more of:
a marketing campaign associated with the retailer or the supplier, the marketing campaign being associated with the first geographical region;
a change in actual demand for the product at the first geographical region or at the second geographical region; or
a change in online consumer activity associated with the product, the change being indicative of increased predicted demand at the first geographical region or decreased predicted demand at the second geographical region.

4. The system of claim 1, wherein the respective numbers of units of the product are allocated to the warehouses at respective different geographical regions based on predicted demand at the respective different geographical regions.

5. The system of claim 4, wherein the processor is configured to execute the instructions to cause the system to:
generate an estimation of the predicted demand based on at least one of: demand for the product at another retailer; demand for another related product; demand for the product category; predicted response to a planned marketing campaign; consumer searches for the product; or consumer views of an online page associated with the product.

6. The system of claim 4, wherein the processor is configured to execute the instructions to cause the system to:
generate an estimation of the predicted demand by assigning a respective demand weight to respective factors; and
calculate an aggregation of weighted factors as an estimation of the predicted demand.

7. The system of claim 6, wherein the factors include at least one of: demand for the product at another retailer; demand for another related product; demand for the product category; predicted response to a planned marketing campaign;
consumer searches for the product; or consumer views of an online page associated with the product.

8. The system of claim 4, wherein the event is detection of actual demand that is mismatched with the predicted demand.

9. The system of claim 1, wherein the respective numbers of units of the product are allocated based on one or more retailer-defined criteria.

10. The system of claim 9, wherein the retailer-defined criteria includes one or more of:
reducing shipping time;
reducing transportation costs;
reducing storage costs; or
reducing carbon emissions.

11. A method of inventory management, comprising:
receiving, from a device associated with a retailer, an order for a total number of units of a product;
allocating the total number of units of the product to the retailer by:
in supplier inventory data associated with a supplier, decreasing unit counts associated with respective different warehouses in respective different geographic regions by respective numbers of units of the product; and
in retailer inventory data associated with the retailer, increasing unit counts associated with the respective different warehouses by the respective numbers of units of the product;
detect an event, the event being indicative of demand for the product at a first geographical region; and
responsive to detecting the event, reallocating a first number of units of the product to a first warehouse at the first geographic location from a second warehouse at a second geographic region by:
in the supplier inventory data, decreasing the unit count associated with the first warehouse by the first number of units and increasing the unit count associated with the second warehouse by the first number of units; and
in the retailer inventory data, increasing the unit count associated with the first warehouse by the first number of units and decreasing the unit count associated with the second warehouse by the first number of units.

12. The method of claim 11, wherein the event is detected in real-time, and wherein the reallocating is performed in real-time with occurrence of the event.

13. The method of claim 11, wherein the event is based on one or more of:
a marketing campaign associated with the retailer or the supplier, the marketing campaign being associated with the first geographical region;
a change in actual demand for the product at the first geographical region or at the second geographical region; or
a change in online consumer activity associated with the product, the change being indicative of increased predicted demand at the first geographical region or decreased predicted demand at the second geographical region.

14. The method of claim 11, wherein the respective numbers of units of the product are allocated to the warehouses at respective different geographical regions based on predicted demand at the respective different geographical regions.

15. The method of claim 14, further comprising:
generating an estimation of the predicted demand based on at least one of: demand for the product at another retailer; demand for another related product; demand for the product category; predicted response to a planned marketing campaign; consumer searches for the product; or consumer views of an online page associated with the product.

16. The method of claim 14, further comprising:
generating an estimation of the predicted demand by assigning a respective demand weight to respective factors; and
calculating an aggregation of weighted factors as an estimation of the predicted demand.

17. The method of claim 14, wherein the event is detection of actual demand that is mismatched with the predicted demand.

18. The method of claim 11, wherein the respective numbers of units of the product are allocated based on one or more retailer-defined criteria.

19. The method of claim 18, wherein the retailer-defined criteria includes one or more of:
reducing shipping time;
reducing transportation costs;
reducing storage costs; or
reducing carbon emissions.

20. A computer-readable medium storing instructions that, when executed by a processor of a system, cause the system to:
receive, from a device associated with a retailer, an order for a total number of units of a product;
allocate the total number of units of the product to the retailer by:
in supplier inventory data associated with a supplier, decreasing unit counts associated with respective different warehouses in respective different geographic regions by respective numbers of units of the product; and
in retailer inventory data associated with the retailer, increasing unit counts associated with the respective different warehouses by the respective numbers of units of the product;
detect an event, the event being indicative of demand for the product at a first geographical region; and
responsive to detecting the event, reallocate a first number of units of the product to a first warehouse at the first geographic location from a second warehouse at a second geographic region by:
in the supplier inventory data, decreasing the unit count associated with the first warehouse by the first number of units and increasing the unit count associated with the second warehouse by the first number of units; and
in the retailer inventory data, increasing the unit count associated with the first warehouse by the first number of units and decreasing the unit count associated with the second warehouse by the first number of units.
